(19) United States
(12) Patent Application Publication
(10) Pub. No.: US 2008/0145054 A1
(43) Pub. Date: Jun. 19, 2008

(54) OPTICAL MODULE WITH OPTICAL FILTER

(76) Inventors: Rei Yamamoto, Tsukuba-shi (JP); Nobuo Miyadera, Tsukuba-shi (JP); Toshihiro Kuroda, Tsukuba-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/021,445

(22) Filed: Jan. 29, 2008

Related U.S. Application Data
(63) Continuation of application No. PCT/JP2006/314757, filed on Jul. 26, 2006.

(30) Foreign Application Priority Data
Jul. 29, 2005 (JP) 2005-221332

(51) Int. Cl. H04J 14/02

(52) U.S. Cl. 398/79

(57) ABSTRACT

An optical module (1) according to the present invention has an optical filter (6) having an input surface (2) and an output surface (4), an input core (8) connected to the input surface (2), and an output core (10) connected to the output surface (4). Assuming that light having a predetermined wavelength is input at an input position (14) and transmitted according to Snell's law, a position at which the light is output from the output surface (4) is referred to as a Snell output position (20). In an equivalent optical filter (6″), the output position (16) is located away from the Snell output position (20) in a direction away from the input position (14) by a distance (D) relating to a group delay.

### FIELD OF THE INVENTION

The present invention relates to an optical module having an optical filter.

### BACKGROUND OF THE INVENTION

As means for transmitting a large volume of information more quickly, a WDM (wavelength division multiplexing) transmission system in which a plurality of lights having respective wavelengths is transmitted through one optical fiber has been focused on, and many systems and optical modules relating to such WDM transmission system have been developed and commercially produced. Regarding the WDM transmission optical module, an optical multiplexer including an optical waveguide and thus allowing integration and downsizing is focused on, which multiplexer has a structure for coupling or splitting lights having respective wavelengths by combining an optical waveguide and a dielectric-multilayer-film-type optical filter. Conventionally, as seen in an optical module for WDM transmission, an optical module having an optical filter (film-type optical filter) is known, which filter has a multilayer film arrangement made by alternately laminating higher-refractive-index layers and lower-refractive-index layers, both layers being made of an inorganic material.

FIG. 6 is a schematic view showing an optical module in which a core of an optical waveguide is obliquely connected to such an optical filter. As shown in FIG. 6, an optical module 100 has an optical filter 106 having an input surface 102 and an output surface 104 which are substantially parallel to each other, an input core 108 connected to the input surface 102, an output core 110 connected to the output surface 104, and claddings 112, 113 respectively disposed around the input and output cores 108, 110. The input core 108 has an input axis 108a and is connected to the input surface 102 at an input position 114, which is an intersection of the input axis 108a with the input surface 102, at a predetermined input angle θᵢ. Similarly, the output core 110 has an output axis 10a and is connected to the output surface 104 at an output position 116, which is an intersection of the output axis 110a with the output surface 104, at a predetermined output angle θₒ. When light is input at the input core 108, the light is refracted at the input surface 102, the output surface 104 and so on and then output to the output core 110, so that the input axis 108a and the output axis 110a are offset relative to each other by a predetermined distance L on the output surface 104. When the refractive index of the input core 108 is equal to that of the output core 110 and the refractive index of the cladding 112 is equal to that of the cladding 113, the input angle θᵢ becomes equal to the output angle θₒ as shown in FIG. 6.

To determine such a predetermined distance L, a method of using Snell's law has been known. FIG. 7 is a view for explaining Snell's law. As shown in FIG. 7, with respect to an interface S, when an input-side refractive index nᵢ is different from an output-side refractive index nₒ, there is a relationship between an input angle θᵢ and an output angle θₒ relative to a perpendicular line Sa of the interface S as expressed by the following Equation 6;

n₁×sin θ₁=n₂×sin θ₂ Equation 6).

FIG. 8 is a schematic view of an optical module in which the distance L is determined by using Snell's law. Components shown in FIG. 8 which are common to those shown in FIG. 6 are indicated by the same reference numbers as those of the latter components, and explanations of the former components are omitted.

As shown in FIG. 8, an optical module 100′ has an optical filter 106′ having an arrangement in which many higher-refractive-index layers 106H and many lower-refractive-index layers 106L are alternately laminated via interfaces 118. Each of the higher-refractive-index layers 106H has a refractive index n_{H} and the total thickness of the thicknesses of the higher-refractive-index layers 106H is referred to as a reference t_{H}. Each of the lower-refractive-index layers 106L has a refractive index n_{L} and the total thickness of the thicknesses of the lower-refractive-index layers 106L is referred to as a reference t_{L}. The input core 108 has a refractive index nᵢ. By applying Snell's law to the input surface 102, each of the interfaces 118 and the output surface 104 of the optical filter 106′, a Snell output position 120 can be determined.

However, it is known that an actual output position of such light is different from the above-stated Snell output position 120 calculated according to Snell's law, as described in the Patent Publication 1 listed later. FIG. 8 shows an output core 132 located at an actual output position 130. According to the Patent Publication 1, a distance δ between the actual output position 130 and the Snell output position 120 is determined by using the following equation 7:

$$δ = A \times tan {θ}_{i} \times ( {t}_{H} \frac{{n}_{i}}{{n}_{H}} + {t}_{L} \frac{{n}_{i}}{{n}_{L}} ) , \qquad ( Equation 7 )$$

wherein the reference A is a value determined according to a wavelength of light input into the optical filter, for example, it is within a range of 0.066-0.075 for an S-type polarized wave having a wavelength of 1300 nm.

Patent Publication 1: Japanese Patent Laid-open Publication No. 2005-31398

The reference A in the Equation 7 can be determined only after some optical filters having a pre-determined film-thickness arrangement are actually made, which film-thickness arrangement is predetermined based on refractive indexes, thicknesses and so on of the higher-refractive-index layers 106H and the lower-refractive-index layers 106L. Thus, the Equation 7 cannot be applied to all optical filters, that is, it cannot be actually applied to an optical filter whose film-thickness arrangement is changed, especially regarding a film-thickness arrangement ratio which indicates a ratio of a total thickness of the higher-refractive-index layers with respect to a total thickness of the lower-refractive-index layers.

Further, when a wavelength of light is changed, a value of δ is changed so that, even if the output position regarding one wavelength is appropriate, the output position regarding another wavelength would not be appropriate. As a result, loss of light regarding the other wavelength is increased so that a problem in optical multiplexing transmission would occur.

Therefore, it is a first object of the present invention to provide a method of determining an output position of an output core of an optical module having an optical filter, which method can be applied to all optical filters at a designing stage thereof in which a film-thickness arrangement of the optical filter is determined, and to provide an optical module in which an output position of an output core is determined by using the above-stated method.

Further, it is a second object of the present invention to provide an optical module with an optical filter to allow for optical multiplexing transmission.

### SUMMARY OF THE INVENTION

The present invention has been thought of by the applicants who have made a great effort to enable an output position with respect to an output core to be determined at a designing stage and have determined that there is a deep relationship between the output position and a group delay of the optical filter.

In order to achieve the object of the present invention, an optical module according to the present invention comprises an optical filter having an input surface and an output surface and having a multilayer film arrangement; an input core connected to the input surface; and an output core connected to the output surface; wherein the input core has an input axis obliquely intersected with the input surface at an input position, and the output core has an output axis intersected with the output surface at an output position; wherein, assuming that light having a predetermined wavelength is input at the input position and transmitted according to Snell's law, a position at which the light is output from the output surface is referred to as a Snell output position, wherein the output position is located away from the Snell output position by a distance D_{f} in a direction away from the input position, and the distance D_{f} is defined by using the following equation;

$${D}_{f} = \frac{GD \times c}{{n}_{f} \times α} \cdot tan {θ}_{f} ;$$

wherein n_{f} is an equivalent refractive index of the optical filter, θ_{f} is an equivalent output angle, GD is a group delay of the optical filter, c is an light speed, and α is a constant within a range of 3-14.

According to this optical module, at a designing stage thereof, once an arrangement of the optical filter is determined, not only an equivalent refractive index n_{f} in an equivalent optical filter in which predetermined light is transmitted from the input position to the Snell output position in a straight line and an equivalent output angle θ_{f} on the input surface therein can be calculated, but also a group delay of the optical filter can be calculated. As a result, at the designing stage, an optical module in which the output position of the output core has been determined can be obtained.

In an embodiment of this optical module, preferably, regarding at least two lights having respective predetermined wavelengths and input into the optical filter, the respective distances D_{f} between the output positions and the Snell output positions corresponding to the predetermined wavelengths are identical to each other.

In this embodiment, regarding at least two lights having respective predetermined wavelengths, the input positions and the output positions are respectively identical to each other. Thus, an optical module allowing for optical multiplexing transmission can be obtained.

Further, in order to achieve the object of the present invention, an optical module according to the present invention comprises an optical filter having an input surface and an output surface and having a multilayer film arrangement; an input core connected to the input surface; and an output core connected to the output surface; wherein the input core has an input axis obliquely intersecting with the input surface at an input position, and the output core has an output axis intersecting with the output surface at an output position; wherein respective output positions, from which at least two lights having respective wavelengths and input at the input position are output, are substantially identical to each other.

This optical module allows for optical multiplexing transmission.

Further, in order to achieve the object of the present invention, a method according to the present invention is a method of determining an output position of an optical module which has an optical filter having an input surface and an output surface and having a multilayer film arrangement; an input core connected to the input surface; and an output core connected to the output surface; the input core having an input axis obliquely intersected with the input surface at an input position, and the output core having an output axis intersected with the output surface at an output position; comprises steps of determining a Snell output position on the output surface from which light having a predetermined wavelength, input at the input position and transmitted according to Snell's law, is output; determining an equivalent refractive index n_{f} of the optical filter and an equivalent output angle θ_{f} at the input surface; determining a distance D_{f} between the output position and the Snell output position by using the following equation;

$${D}_{f} = \frac{GD \times c}{{n}_{f} \times α} \cdot tan {θ}_{f}$$

wherein GD is an group delay, c is an light speed, and α is a constant within a range of 3-14; and determining a position of the output position located away from the Snell output position by the distance D_{f} in a direction away from the input position. A value of α is within a range of, preferably, 5-12, more preferably, 7-10, and much more preferably, 8-9.

According to the present invention, a method of determining an output position of the output core of the optical module having an optical filter can be obtained, which method can be applied to all optical filters at a designing stage thereof, and further an optical module in which the output position of the output core is determined by using the above-stated method can be obtained.

Further, according to the present invention, an optical module having an optical filter and allowing for optical multiplexing transmission can be obtained.

### BRIEF DESCRIPTION OF THE DRAWINGS

In the accompanying drawings:

FIG. 1 is a graph showing an example of a relationship between a transmittance and a group delay;

FIG. 2 is a schematic view of an optical module according to the present invention;

FIG. 3 is a schematic view of an optical module equivalent to that shown in FIG. 2;

FIG. 4 is a schematic view of an optical module equivalent to that shown in FIG. 2;

FIG. 5 is a schematic view of an optical module formed by interposing an adhesive in the optical module shown in FIG. 2;

FIG. 6 is a schematic view of a conventional optical module in which a core of an optical waveguide is obliquely connected to an optical filter.

FIG. 7 is a view for explaining Snell's law; and

FIG. 8 is a schematic view of an optical module in which a distance L is determined by using Snell's law.

### DETAILED DESCRIPTION OF THE PREFERRED EMBODIMENTS

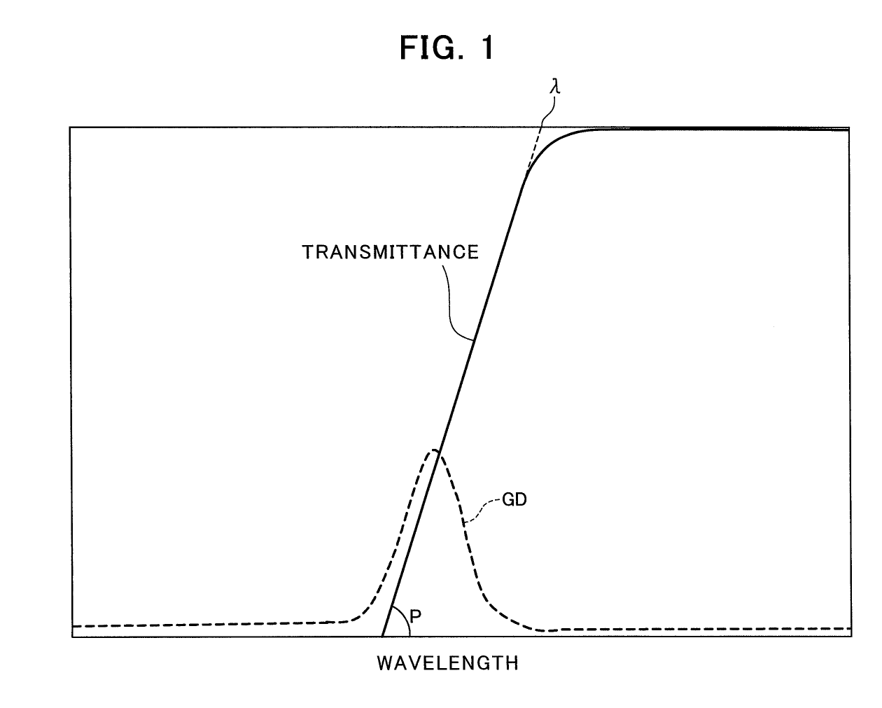

As explained above, the present invention has been made by focusing on a group delay of an optical filter. The group delay of the optical filter is an extra time period during which light transmitted through the optical filter is confined therein. FIG. 1 is a graph showing an example of a relationship between a transmittance and a group delay of an optical filter with respect to optical wavelengths. As shown in FIG. 1, the group delay GD of the optical filter can be calculated by differentiating a propagation coefficient with an angular frequency and then multiplying the result of differentiation with a propagated distance. For example, a horizontal axis of the graph in FIG. 1 indicates wavelengths and thus FIG. 1 teaches that the amount of group delay GD is determined according to a varying amount of the transmittal ratio of the optical filter.

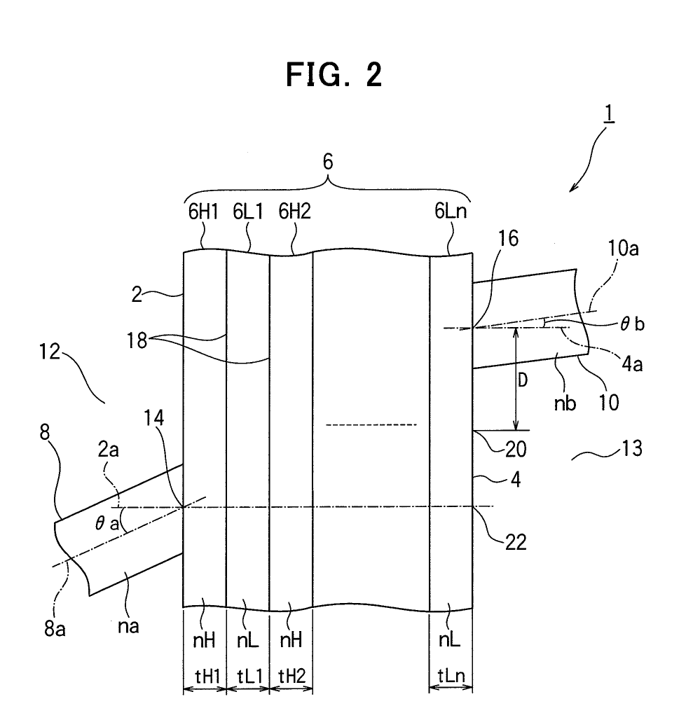

Now, referring to Figures, an optical module according to the present invention will be explained. As shown in FIG. 2, an optical module 1 has an optical filter 6 having an input surface 2 and an output surface 4 which are substantially parallel to each other, an input core 8 connected to the input surface 2, an output core 10 connected the output surface 4, and claddings 12, 13 respectively disposed around the input and output cores 8, 10. The input core 8 has an input axis 8a and a refractive index nₐ. The input axis 8a and the input surface 2 are obliquely intersected with each other at an input position 14, which is an intersection thereof, at an input angle θₐ relative to a perpendicular line 2a of the input surface 2. Similarly, the output core 10 has an output axis 10a and a refractive index n_{b}. The output axis 10a and the output surface 4 are obliquely intersected with each other at an output position 16, which is an intersection thereof, at an output angle θ_{b} relative to a perpendicular line 4a of the output surface 4.

When the refractive index of the input core 8 is equal to that of the output core 10 and the refractive index of the cladding 12 is equal to that of the cladding 13, the input angle θₐ becomes equal to the output angle θ_{b} (not shown).

The optical filter 6 has a multilayer film arrangement in which higher-refractive-index layers 6H1, 6H2, . . . , 6Hn and lower-refractive-index layers 6L1, 6L2, . . . , 6Ln are alternately laminated via interfaces 18. The higher-refractive-index layers 6H1, 6H2, . . . , 6Hn have respective thicknesses tH1, tH2, . . . , tHn and a common refractive index nH. Similarly, the lower-refractive-index layers 6L1, 6L2, . . . , 6Ln have respective thicknesses tL1, tL2, . . . , tLn and a common refractive index nL.

When light having a predetermined wavelength is input at the input position 14 and transmitted according to Snell's law, a position at which the light is output from the output surface 4 is referred to as a Snell output position 20. An actual output position 16 is offset from the Snell output position 20 by a distance D in a direction away from the input position 14. Further, an intersection of the perpendicular line 2a with the output surface 4 is referred to as a corresponding input position 22.

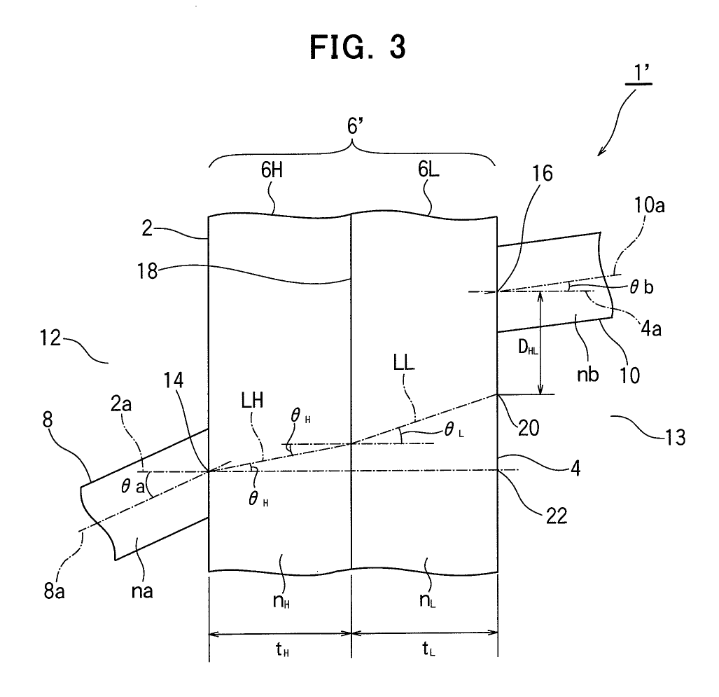

FIG. 3 is a schematic view of an optical module equivalent to the optical module shown in FIG. 2. Components shown in FIG. 3, which are common to those shown in FIG. 2, are indicated by the same reference numbers as those of the latter components, and explanations of the former components are omitted. In the equivalent optical module 1′ shown in FIG. 3, an optical filter 6′ has a two-layer arrangement, namely, a higher-refractive-index layer 6H and a lower-refractive-index layer 6L. The higher-refractive-index layer 6H has a thickness t_{H} and a refractive index n_{H}. The thickness t_{H} is equal to the total of the thicknesses tH1, tH2, . . . , tHn shown in FIG. 2. Similarly, the lower-refractive-index layer 6L has a thickness t_{L} and a refractive index n_{L}. The thickness t_{L} is equal to the total of the thicknesses tL1, tL2, . . . , tLn shown in FIG. 2.

In FIG. 3, a path of the light in the higher-refractive-index layer 6H according to Snell's law is indicated by a reference LH, and a path of the light in the lower-refractive-index layer 6L according to Snell's law is indicated by a reference LL. The output angle θ_{H} of the former light path LH at the input surface 2 and the output angle θ_{L} of the latter light path LL at the interface 18 can be calculated from the relationship indicated in the Equation 1. Further, a distance D_{HL} between an output position 20 of the light obtained by calculation according to Snell's law and the output position 16 of the output core 10 can be calculated by using the Equation 2. In the Equation 2, a reference GD indicates a group delay, a reference c indicates an light speed, and references α₁, α₂ indicate constants. Values of the constants α₁ and α₂ are separately determined within a range of 3-14, preferably 5-12, more preferably 7-10 and much more preferably 8-9.

$$\begin{matrix} {n}_{a} \times sin {θ}_{a} = {n}_{H} \times sin {θ}_{H} = {n}_{L} \times sin {θ}_{L} & ( Equation 1 ) \\ {D}_{HL} = \frac{GD \times c}{{n}_{H} \times {α}_{1}} \cdot \frac{{t}_{H}}{{t}_{H} + {t}_{L}} tan {θ}_{H} + \frac{GD \times c}{{n}_{L} \times {α}_{2}} \cdot \frac{{t}_{L}}{{t}_{H} + {t}_{L}} tan {θ}_{L} & ( Equation 2 )\end{matrix}$$

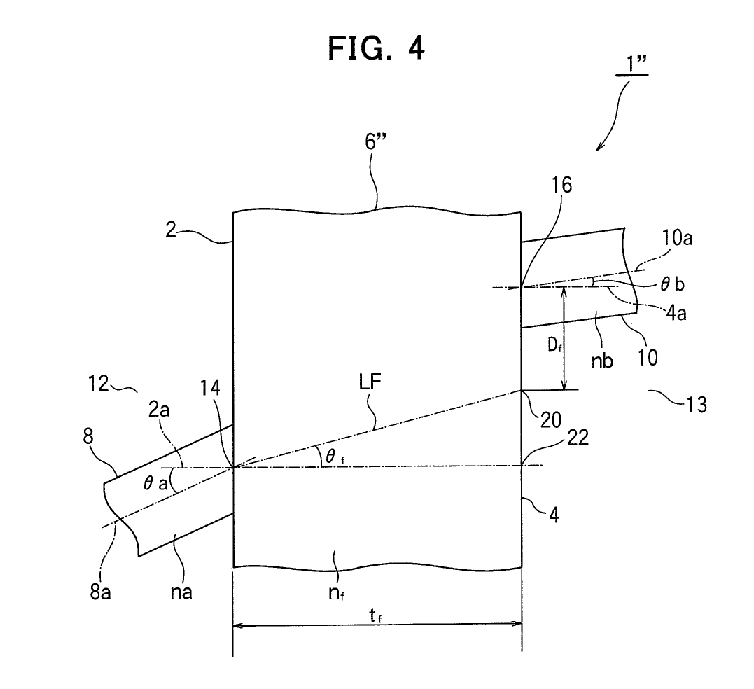

FIG. 4 is a schematic view of an optical module which is equivalent to the optical modules shown in FIGS. 2 and 3. Components shown in FIG. 4 which are common to those shown in FIG. 2 are indicated by the same reference numbers as those of the latter components, and explanations of the former components are omitted. An equivalent optical module 1″ shown in FIG. 4 has an equivalent optical filter 6″ having a one-layer arrangement. The equivalent optical filter 6″ has a thickness t_{f} and an equivalent refractive index n_{f}. The thickness t_{f} is equal to the total of the thicknesses tH1, tH2, . . . , tHn and tL1, tL2, . . . , tLn, namely, the sum of the thicknesses t_{H} and t_{L}. The equivalent refractive index n_{f} can be calculated by using the Equation 3;

$${n}_{f} = {n}_{H} \times \frac{{t}_{H}}{{t}_{H} + {t}_{L}} + {n}_{L} \times \frac{{t}_{L}}{{t}_{H} + {t}_{L}} . \qquad ( Equation 3 )$$

In FIG. 4, when light having a predetermined wavelength is input at the input position 14, transmitted according to Snell's law, and output at the Snell output position 20 in the output surface 4, an equivalent path is indicated by a reference LF along which the light is transmitted between the input position 14 and the Snell output position 20 in a straight line. The equivalent output angle θ_{f} of the light equivalent path LF at the input surface 2 can be calculated by using a relationship indicated in the Equation 4. Further, a distance D_{f} between the output position 16 of the output core 10 and the Snell output position 20 can be calculated by using the Equation 5. In the Equation 5, a reference GD indicates a group delay, a reference c indicates an lightspeed, and a reference α indicates a constant. A value of the constant α is within a range of 3-14, preferably 5-12, more preferably 7-10 and much more preferably 8-9. The output position 16 is apart from the Snell output position 20 by the distance D_{f} in a direction away from the input position 14. The distance D_{f} between the output position 16 and the Snell output position 20 is preferably the same regarding at least two lights input into the optical filter 6 and having respective predetermined wavelengths.

$$\begin{matrix}{n}_{a} \times sin {θ}_{a} = {n}_{f} \times sin {θ}_{f} & ( Equation 4 ) \\ {D}_{f} = \frac{GD \times c}{{n}_{f} \times α} \cdot tan {θ}_{f} & ( Equation 5 )\end{matrix}$$

In the optical modules 1, 1′, 1″, light input at the input position 14 of the input core 8 is transmitted through the optical filters 6, 6′, 6″ and then output from the output position 16 of the output core 10.

Next, a way of designing the optical module will be explained referring to an example in which lights having respective wavelengths of 1310 nm, 1490 nm and 1550 nm are transmitted. As the optical filter 6, an SPF (shortwave length pass filter) is used, through which lights having respective wavelengths of 1310 nm and 1490 nm are transmitted and at which light having a wavelength of 1550 nm is reflected.

Once a film-thickness arrangement of the optical filter 6 is determined, an equivalent refractive index n_{f} and an equivalent output angle θ_{f} are calculated by using the Equations 3 and 4. Further, by using angle frequencies corresponding to the respective wavelengths of 1310 nm and 1490 nm of lights transmitted through the optical filter 6, group delays GD of the optical filter 6 corresponding to the respective wavelengths are calculated. By substituting the calculated values of the equivalent refractive index n_{f}, the equivalent output angle θ_{f} and the group delay GD for those in the Equation 5, the distances D_{f} are calculated.

If distances D_{f} corresponding to the optical wavelengths of 1310 nm and 1490 nm are different from each other, the group delay GD of the optical filter 6 is adjusted so that such distances D_{f} are equal to each other. Concretely, a property or a film-thickness arrangement of the optical filter 6 is adjusted by changing, in FIG. 1, a wavelength position λ at which a transmittance suddenly starts to change and/or a rate P of change (gradient) of the transmittance relative to a change of the wavelength.

Thus, when the lights having the respective wavelengths of 1310 nm and 1490 nm are input at the input position 14, both of them are output from the output position 16.

When an optical filter 6 is used, in which a kind thereof is an SPF and the distances D_{f} are made equal to each other relative to both of the lights having the respective wavelengths of 1310 nm and 1490 nm by adjusting the group delay regarding the same wavelengths, a property of the optical filter 6 in which losses regarding both of the wavelengths are reduced can be obtained.

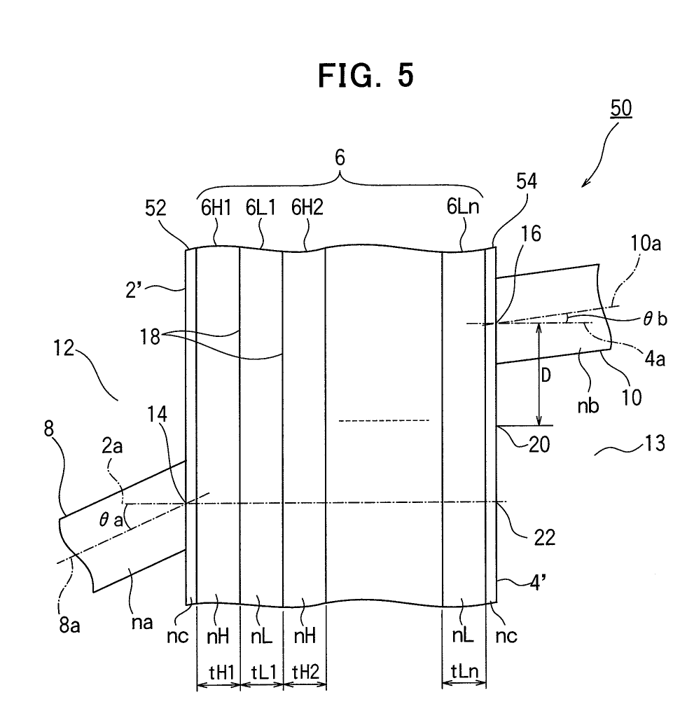

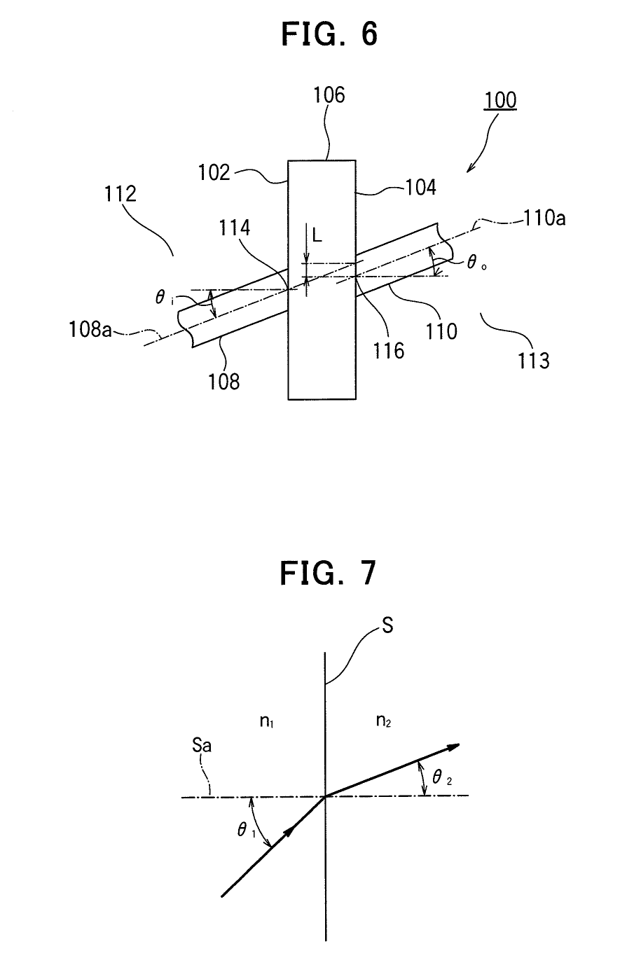

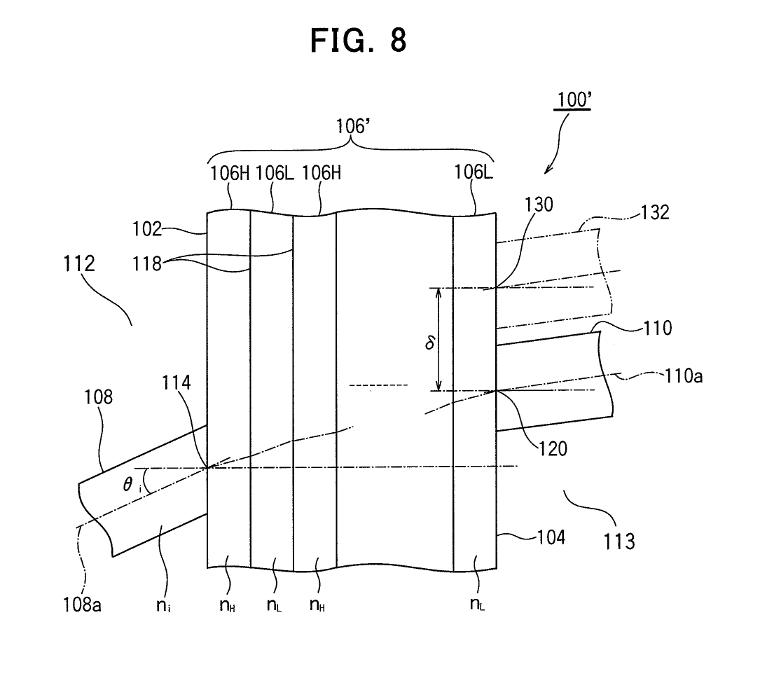

FIG. 5 is a schematic view of an optical module formed by interposing an adhesive in the optical module shown in FIG. 2. An adhesive 52 is interposed between the optical filter 6 and the input core 8 of the optical module 50, and an adhesive 54 is interposed between the optical filter 6 and the output core 10 thereof. The adhesives 52, 54 respectively define an input surface 2′ and an output surface 4′ and have a refractive index n_{c}. The input axis 8a is obliquely intersected with the input surface 2′ at an input position 14, which is an intersection of the input axis 8a and the input surface 2′, at an input angle θₐ relative to a perpendicular line 2a of the input surface 2′. Similarly, the output axis 10a is obliquely intersected with the output surface 4′ at an output position 16, which is an intersection of the output axis 10a and the output surface 4′, at an output angle θ_{b} relative to a perpendicular line 4a of the output surface 4′. Assuming that light having an predetermined wavelength and input at the input position 14 is transmitted according to Snell's law, a position on the output surface 4′ from which the light is output is referred to as a Snell output position 20.

In the optical module 50 shown in FIG. 5, by applying Snell's law to light transmitted through the adhesives 52, 54 and applying the above-stated calculation method explained with reference to FIGS. 2-5 to light transmitted through the optical filter 6, distances D, D_{HL}, D_{f} between the output position 16 and the Snell output position 20 can be obtained.

Next, a calculated result regarding an optical module described in the above-stated Patent Publication 1 will be explained. Table 1 shows the refractive index of the input core 108 nᵢ, the refractive index n_{H} of the higher-refractive-index layer 106H, the refractive index n_{L} of the lower-refractive-index 106L, and distances δ calculated by using the Equation 7 in the following conditions; the wavelengths of light are 1300 nm, 1490 nm and 1500 nm; t_{H}=6 μm; t_{L}=12 μm; and θᵢ=8°. As shown in Table 1, distances δ are greatly changed according to the wavelengths of light and thus the optical module is apparently not suitable for transmitting at least two lights having respective wavelengths at small losses.

TABLE 1

| | Wavelength of Light | | |
|---|---|---|---|
| | 1300 nm | 1490 nm | 1500 nm |
| n_{H} | 2.232 | 2.227 | 2.227 |
| n_{L} | 1.459 | 1.458 | 1.458 |
| nᵢ | 1.485 | 1.483 | 1.483 |
| A (S-type Polarized | 0.066-0.075 | 0.40-0.50 | 0.06-0.09 |
| Wave) | | | |
| δ | 0.15-0.17 μm | 0.91-1.14 μm | 1.37-2.05 μm |

The embodiment of the present invention has been explained, but the present invention is not limited to the above-mentioned embodiment and it is apparent that the embodiment can be changed within the scope of the present invention set forth in the claims.

In the above-stated embodiment, although the input surface 2 is defined by the higher-refractive-index layer, while the output surface 4 is defined by the lower-refractive-index layer, the input surface 2 may be defined by the lower-refractive-index layer and/or the output surface 4 may be defined by the higher-refractive-index layer.

The refractive index of the input core 8 may be equal to or different from that of the output core 10. Further, the refractive index of the input-side cladding 12 may be equal to or different from that of the output-side cladding 13. Further, as the input core 8 and/or the output core 10, a core of an optical waveguide, an optical fiber and so on may be used. For example, a combination of the input core 8 and the cladding 12 may be defined by an optical fiber with a glass block and/or a combination of the output core 10 and the cladding 13 may be defined by an optical waveguide.

What is claimed is:

1. An optical module comprising:
an optical filter having an input surface and an output surface and having a multilayer film arrangement;
an input core connected to the input surface; and
an output core connected to the output surface;
wherein the input core has an input axis obliquely intersected with the input surface at an input position, and the output core has an output axis intersected with the output surface at an output position;
wherein, assuming that light having a predetermined wavelength is input at the input position and transmitted according to Snell's law, a position at which the light is output from the output surface is referred to as a Snell output position; and
wherein the output position is located away from the Snell output position by a distance Df in a direction away from the input position, and the distance D_{f} is defined by using the following equation;
$${D}_{f} = \frac{GD \times c}{{n}_{f} \times α} \cdot tan {θ}_{f}$$
wherein n_{f} is an equivalent refractive index of the optical filter, θ_{f} is an equivalent output angle, GD is a group delay of the optical filter, c is an light speed, and α is a constant within a range of 3-14.

2. The optical module according to claim 1,
wherein, regarding at least two lights having respective predetermined wavelengths and input into the optical filter, the respective distances D_{f} between the output positions and the Snell output positions corresponding to the predetermined wavelengths are identical to each other.

3. An optical module comprising:
an optical filter having an input surface and an output surface and having a multilayer film arrangement;
an input core connected to the input surface; and
an output core connected to the output surface;
wherein the input core has an input axis obliquely intersecting with the input surface at an input position, and the output core has an output axis intersecting with the output surface at an output position;
wherein respective output positions, from which at least two lights having respective wavelengths and input at the input position are output, are substantially identical to each other.

4. A method of determining an output position of an optical module which has an optical filter having an input surface and an output surface and having a multilayer film arrangement; an input core connected to the input surface; and an output core connected to the output surface; the input core having an input axis obliquely intersected with the input surface at an input position, and the output core having an output axis intersected with the output surface at an output position; comprising steps of
determining a Snell output position on the output surface from which light having a predetermined wavelength, input at the input position and transmitted according to Snell's law, is output;
determining an equivalent refractive index n_{f} of the optical filter and an equivalent output angle θ_{f} at the input surface;
determining a distance D_{f} between the output position and the Snell output position by using the following equation
$${D}_{f} = \frac{GD \times c}{{n}_{f} \times α} \cdot tan {θ}_{f}$$
wherein GD is an group delay, c is an light speed, and α is a constant within a range of 3-14; and
determining a position of the output position located away from the Snell output position by the distance D_{f} in a direction away from the input position.
